(19) United States
(12) Patent Application Publication
(10) Pub. No.: US 2015/0275781 A1
(43) Pub. Date: Oct. 1, 2015

(54) ENGINE FUEL ENHANCEMENT MANAGEMENT SYSTEM

(71) Applicants: William Bill Matar, Lakemba (AU); James Leonard Gordon Hill, Appin (AU); Michael Anthony Redford, Earlwood (AU); Russell Leonard Hill, Appin (AU)

(72) Inventors: William Bill Matar, Lakemba (AU); James Leonard Gordon Hill, Appin (AU); Michael Anthony Redford, Earlwood (AU); Russell Leonard Hill, Appin (AU)

(73) Assignee: HEMS System Pty Ltd., St Peters (AU)

(21) Appl. No.: 14/422,623

(22) PCT Filed: Aug. 20, 2012
(86) PCT No.: PCT/AU2012/000975

§ 371 Date: Jun. 5, 2015

(51) Int. Cl. F02D 19/06; F02M 25/10

(52) U.S. Cl. CPC F02D 19/0644; F02M 25/10; F02D 19/0605; F02D 19/0607

(57) ABSTRACT

A system (10) for managing the addition of a fuel additive to an engine (202) which receives a conventional fuel, the system (10) comprising, a storage means (12) for storing the fuel additive, a supply line (15) communicating the storage means (12) to the engine (202), and a control valve (26) for controlling the rate of addition of the fuel additive from the storage means (12) to the engine (202).

### FIELD OF THE INVENTION

The present invention relates to an engine fuel enhancement management system and in particular to a management system for adding hydrogen gas as a fuel enhancer to an internal combustion engine.

The invention has been developed primarily for use with internal combustion engines and will be described hereinafter with reference to this application. However, it will be appreciated that the invention is not limited to this particular field of use.

### BACKGROUND OF THE INVENTION

There are existing systems for using hydrogen gas as a fuel enhancer in an internal combustion engine. Existing systems control flow of hydrogen gas into the inlet manifold of an engine by use of a fixed pressure regulator which is set to produce a set flow at atmospheric pressure. This resulted in inconsistent flow of hydrogen gas during engine operation due to the varying pressure within the engine inlet manifold which varied dramatically during vacuum and/or boost. These existing systems have thus been inefficient in fulfilling the intentions of adding hydrogen gas to the fuel mix.

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

According to a first aspect, the present invention provides a system for managing the addition of a fuel additive to an engine which receives a conventional fuel, the system comprising:
a storage means for storing the fuel additive;
a supply line communicating the storage means to the engine; and
a control valve for controlling the rate of addition of the fuel additive from the storage means to the engine.

Preferably, the control valve is a proportional valve disposed in the supply line.

Preferably, the system further comprises a control means for dynamically controlling the control valve to vary the rate of flow of fuel additive to the engine in response to current intake manifold pressure and/or throttle position of the engine.

Preferably, the storage means is a high pressure storage cylinder, which is fixed and refillable, or exchangeable.

Preferably, the system comprises a high pressure to low pressure regulator valve in the supply line for converting high pressure fuel additive in the storage cylinder to a lower pressure.

Preferably, the system comprises a manual high pressure cylinder shut off valve connected to the storage cylinder.

Preferably, the supply line comprises a low pressure supply line portion which extends downstream from the regulator valve, the system comprising a low pressure shut off valve in the low pressure supply line portion.

Preferably, the system comprises a low pressure shut off valve disposed in the regulator valve.

Preferably, the system comprises a control unit which controls the low pressure shut off valve.

Preferably, the control valve comprises a proportional valve in the supply line, the supply line comprising a metered hydrogen line which extends from the proportional valve to the engine.

Preferably, the system comprises a control unit which controls the proportional valve.

Preferably, the system comprises a master switch and indicator means.

Preferably, the fuel additive is hydrogen gas which is stored in the storage means in compressed form.

Preferably, the low pressure cylinder shut off valve is an electronically controlled solenoid shut off valve.

Preferably, the proportional valve is an electronically controlled proportional solenoid valve.

Preferably, the control means is an integrated logic control unit.

Preferably, the integrated logic control unit is a programmable integrated circuit.

According to another aspect, the present invention provides a system for managing the addition of a fuel additive to an engine which receives a conventional fuel, wherein the supply of conventional fuel to the engine is managed by an engine control module, the system comprising:
a storage means for storing the fuel additive;
a supply line communicating the storage means to the engine; and
a control means for controlling the rate of addition of the fuel additive from the storage means to the engine, wherein the control means is adapted to send a modified signal to the engine control module for the engine control module to supply a reduced amount of conventional fuel to the engine when the system is operating.

Preferably, the control means comprises a control unit, the system further comprising a control valve in the supply line and wherein the control unit dynamically controls the control valve to vary the rate of flow of fuel additive to the engine in response to current intake manifold pressure and/or throttle position of the engine.

Preferably, the system comprises a high pressure to low pressure regulator valve in the supply line for converting high pressure fuel additive in the storage means to a lower pressure.

Preferably, the supply line comprises a low pressure supply line portion which extends downstream from the regulator valve, the system comprising a low pressure shut off valve in the low pressure supply line portion, wherein the control unit controls the low pressure shut off valve.

Preferably, the fuel additive is hydrogen gas which is stored in the storage means in compressed form.

Preferably, the low pressure shut off valve is an electronically controlled solenoid shut off valve.

Preferably, the control valve is an electronically controlled proportional solenoid valve.

Preferably, the control means is an integrated logic control unit.

Preferably, the system operates independently of the engine control module.

According to another aspect, the present invention provides a system for managing the addition of a fuel additive to an engine which receives a conventional fuel, the system comprising:
a storage means for storing the fuel additive;
a supply line communicating the storage means to the engine; and
a control means for controlling the rate of addition of the fuel additive from the storage means to the engine, wherein the control means is adapted to add the fuel additive to the engine across an engine operating range between and including engine idle and engine full throttle.

According to another aspect, the present invention provides a system for managing the addition of a fuel additive to an engine which receives a conventional fuel, the system comprising:
a storage means for storing the fuel additive;
at least two supply lines communicating the storage means to the engine which are adapted to supply the fuel additive to the engine at different rates of flow; and
a switching means for selecting the rate of flow of addition of the fuel additive to the engine between the at least two supply lines.

Preferably, each of the at least two supply lines comprise a respective regulator valve.

Preferably, each of the at least two supply lines comprise a respective shut off valve.

Preferably, the switching means is connected to the shut off valves.

Preferably, the switching means comprises a pressure differential solenoid switch which monitors the manifold pressure of the engine.

According to another aspect, the present invention provides a method of managing the addition of a fuel additive to an engine which receives a conventional fuel, the method comprising:
dynamically controlling the rate of flow of the fuel additive from a storage means to the engine in response to current intake manifold pressure and/or throttle position of the engine.

Preferably, the method further comprises the step of sending a modified signal to an engine control module of the engine, for the control module to supply a reduced amount of conventional fuel to the engine when the fuel additive is being added to the engine.

According to another aspect, the present invention provides a method of managing the addition of a fuel additive to an engine which receives a conventional fuel, the method comprising:
sending a modified signal to an engine control module of the engine, for the control module to supply a reduced amount of conventional fuel to the engine when the fuel additive is being added to the engine.

Preferably, the method further comprises the step of dynamically controlling the rate of flow of the fuel additive from a storage means to the engine in response to current intake manifold pressure and/or throttle position of the engine.

According to another aspect, the present invention provides an engine having the system of the above installed therein.

According to another aspect, the present invention provides a vehicle having the system of the above installed therein.

Other aspects of the invention are also disclosed.

### BRIEF DESCRIPTION OF THE DRAWINGS

Notwithstanding any other forms which may fall within the scope of the present invention, preferred embodiments of the present invention will now be described, by way of examples only, with reference to the accompanying drawings in which:

FIG. 1 is a schematic layout diagram of an engine fuel enhancement management system in accordance with a first preferred embodiment of the present invention, the system being installed in a car;

FIG. 2 is a schematic circuit diagram of the system of FIG. 1;

FIG. 3 is a schematic block diagram of the system of FIG. 1;

FIG. 4 is a schematic block diagram of a simplified engine fuel enhancement management system in accordance with a second preferred embodiment of the present invention;

FIG. 5 is a schematic circuit diagram of a safety switching system for the engine fuel enhancement management system of FIG. 4;

FIG. 6 is a schematic circuit diagram of an alternative safety switching system for the engine fuel enhancement management system of FIG. 4;

FIG. 7 is a schematic block diagram of an engine fuel enhancement management system in accordance with a third preferred embodiment of the present invention;

FIG. 8 is a sample diagram showing manifold pressure and rate of hydrogen flow to a petrol engine across the full range of throttle position;

FIG. 9 is a sample diagram showing manifold pressure and rate of hydrogen flow to a turbo diesel engine across the full range of throttle position; and

FIG. 10 is a sample diagram showing manifold pressure and rate of hydrogen flow to a normally aspirated diesel engine across the full range of throttle position.

### DESCRIPTION OF EMBODIMENTS

It should be noted in the following description that like or the same reference numerals in different embodiments denote the same or similar features.

### First Embodiment

### System Components

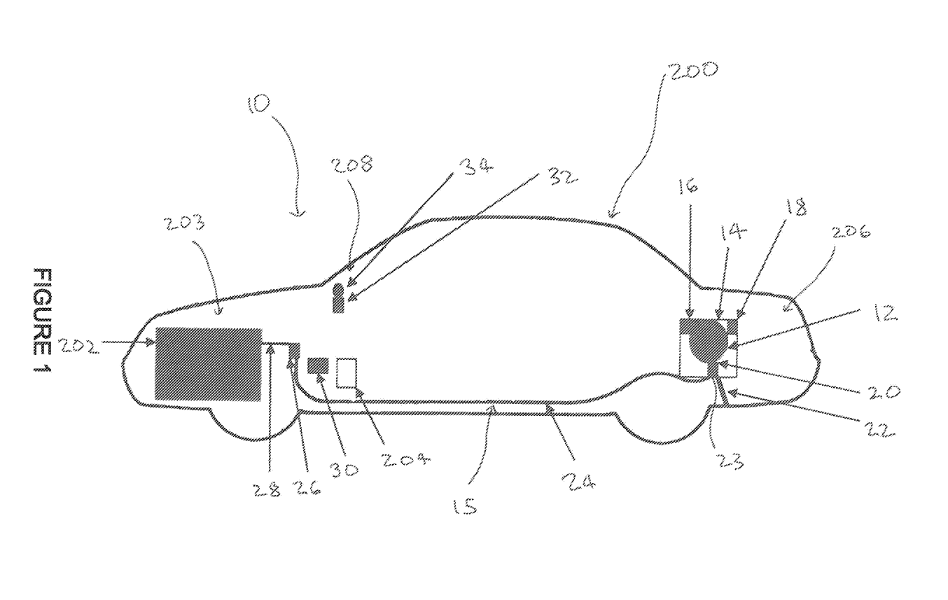

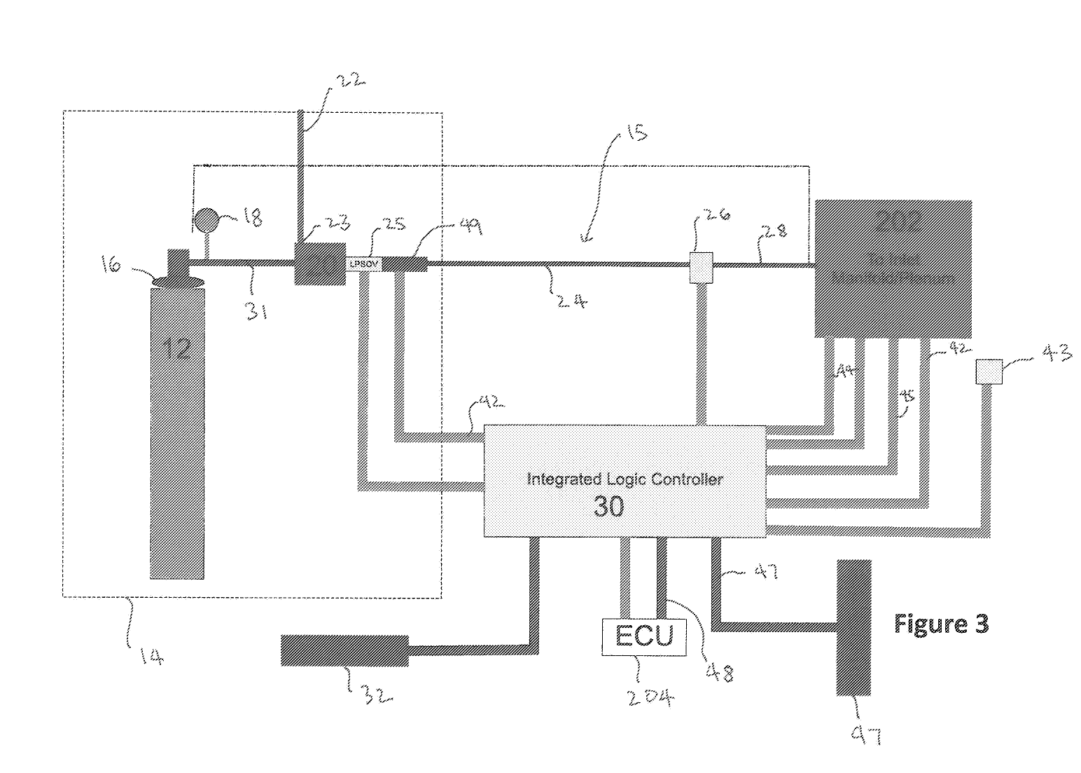

FIGS. 1 to 3 show an engine fuel enhancement management system 10 in accordance with a first preferred embodiment of the present invention installed in a vehicle 200, which in the embodiment is a car. The vehicle 200 as is known comprises an engine 202 disposed in an engine bay 203 which receives conventional fuel from a conventional fuel tank (not shown) via a conventional fuel line (not shown). The conventional fuel tank is typically disposed adjacent to the boot 206 of the vehicle 200. The supply of conventional fuel to the engine is managed by an engine control module (ECM) 204.

The conventional fuel can be a liquid fuel (bio fuel, petrol, diesel or kerosene based fuel), gaseous fuel (CNG), liquid petroleum gas (LPG), or a combination thereof. The engine 202 can be any type of fuelled internal combustion engine (e.g. reciprocating, rotary or turbine).

The system 10 comprises a storage means 12 for the fuel additive which in the embodiment is a high pressure storage cylinder 12, disposed within a sealed enclosure 14. The enclosure 14 in the embodiment is disposed within the boot 206 of the vehicle 200. Also disposed within the enclosure 14 and connected to the storage cylinder 12 are a manual cylinder shut off valve 16, a high pressure gauge 18, and a high pressure to low pressure regulator valve 20. As an alternative or in addition to the sealed enclosure 14, the regulator valve 20 can include a pressure relief valve 23 which is vented externally via a vent 22 which extends to an external surface of the vehicle 200.

The system 10 further comprises a supply line 15 communicating the storage means 12 to the engine 202. The supply line 15 comprises a high pressure supply line portion 31 connecting the storage cylinder 12 to the high pressure to low pressure regulator valve 20. The supply line 15 also comprises a low pressure supply line portion 24 which extends from the regulator valve 20 to a flow control valve 26 which in the embodiment is a proportional valve, and a metered hydrogen line portion 28 which extends from the proportional valve 26 to the engine 202.

The system 10 further comprises a low pressure shut off valve 25 disposed either at the low pressure supply line portion 24 or in the regulator valve 20. The proportional valve 26 and the metered hydrogen line 28 are disposed within the engine bay 203 with the low pressure supply line 24 extending from the boot 206 to the engine bay 203.

The system 10 further comprises a programmable integrated logic control unit 30 which controls the operation of the system 10 as further described below. Disposed within the vehicle instrument panel 208 are a master switch 32 for the system 10 and indicator lights 34 which are connected to the integrated logic control unit 30.

The fuel additive in the embodiment is hydrogen gas and the storage cylinder 12 stores commercially produced compressed hydrogen gas. This hydrogen gas is of high purity and produced by refineries as a gas or converted during use to a gas from liquid hydrogen.

The objective of the system 10 is the effective addition of a metered amount of hydrogen gas (fuel additive) into the fuel/air mixture entering the combustion chamber(s) of the engine 200, during all operation conditions of the engine 202, across the full range of manifold pressure and throttle position. The system 10 dynamically controls the rate of flow of hydrogen gas to the combustion chamber(s) in response to present manifold pressure and throttle position. This is to maximise the efficiency of the combustion process, reduce negative greenhouse gas emissions and improve the power and fuel economy of the engine 200.

The storage cylinder 12 is an ASA (American Standards Association) or ISO (International Organization for Standardization) compliant high pressure storage cylinder which stores hydrogen gas at a pressure of about 200 Bar. The gas storage 12 can be refillable within the vehicle 200 and/or replaceable. The high pressure cylinder shut off valve 16 is a hand operated manual shut off valve. The high pressure gauge 18 measure pressure of hydrogen gas in the high pressure supply line portion 31.

The high pressure to low pressure regulator valve 20 converts high pressure hydrogen gas from the storage cylinder 12 of about 200 BAR to a low pressure up to 3 BAR, as preset during system installation. The pressure regulator valve 20 can incorporate a flash back arrestor, non return valve and the pressure relief valve 23. The low pressure shut off valve 25 is an electronically controlled solenoid shut off valve which is connected to and controlled by the integrated logic control unit 30. The low pressure shut off valve 18 is a normally closed valve which has to be powered open by the integrated logic control unit 30 to allow flow therethrough.

The low pressure supply line 24 conveys the low pressure hydrogen gas to the proportional valve 26, which is an electronically controlled proportional solenoid valve connected to and controlled by the integrated logic control unit 30. The proportional valve 26 is also a normally closed valve which has to be powered open by the integrated logic control unit 30 to allow flow therethrough. The integrated logic control unit 30 dynamically controls the size of the opening of the proportional valve 26 in response to present throttle and manifold pressure status to thus vary the rate of flow of hydrogen gas flowing into the metered hydrogen line 28.

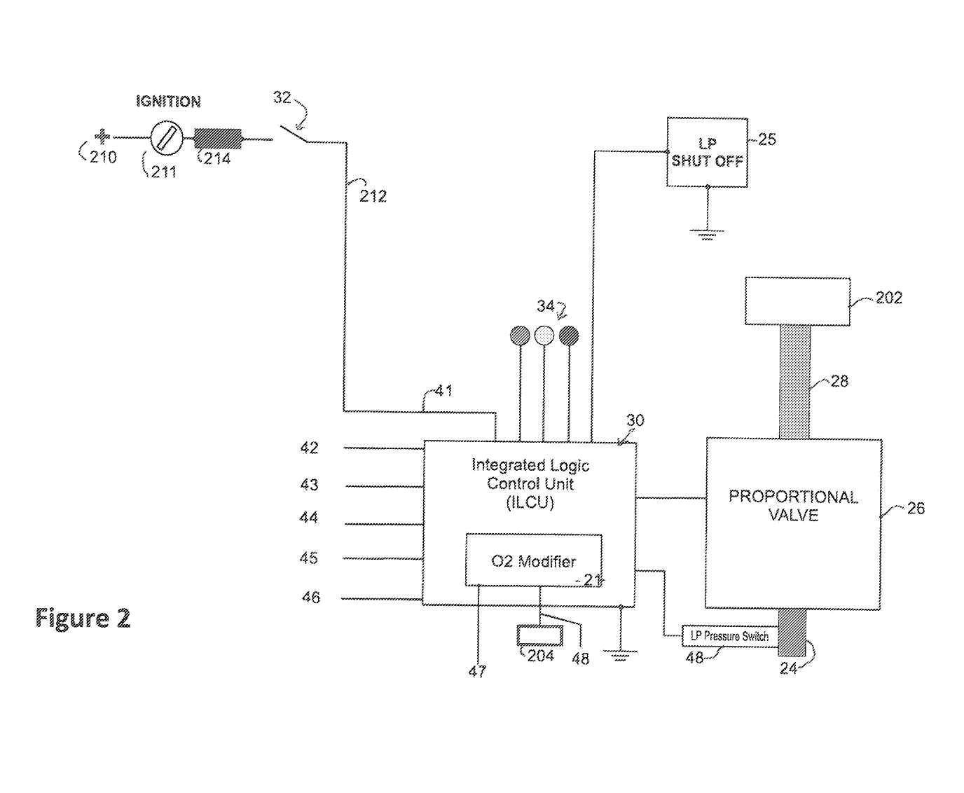

Referring to FIG. 2, the integrated logic control unit 30 is a programmable integrated circuit that monitors a number of system signals which indicate the status or position of various components of the system 10 or the engine 200. The integrated logic control unit 30 then takes action depending on the signals received. These signals can include:
master switch position 41, indicating on or off position of master switch 32;
engine manifold pressure status 42, which indicates current manifold pressure via a pressure transducer 49;
thermal sensor status 43, which indicates whether the engine is overheating to such an extent that the risk of an engine compartment fire may exist;
alternator output or oil pressure status 44, which indicates whether engine is running or not (engine OFF or ON signal);
throttle position switch status 45, which indicates the throttle position;
barometric pressure sensor signal 46, which indicates current altitude for aviation applications,
oxygen sensor status 47, which receives a signal from the current oxygen sensor of the vehicle 200;
low hydrogen pressure status 48 in the low pressure line 24, which indicates storage cylinder 12 is close to empty; and
other signals as applicable to the engine 202 to which the system 10 is fitted to.

With the combination of monitored signals, the integrated logic control unit 30 will control the rate of flow of hydrogen gas to the inlet manifold 201 of the engine 202 at a programmed rate applicable for the range of operation of the engine 202 via the proportional valve 26. The integrated logic control unit 30 dynamically varies the position of the proportional valve 26 to provide the required hydrogen gas flow rate.

In the normal operation of the engine 202, the engine control module (ECM) 204 controls the rate of flow of conventional fuel to the engine inlet manifold 201 in accordance with a status signal received from the oxygen sensor 47. The integrated logic control unit 30 comprises an oxygen signal modifier 21 which will provide a modified oxygen signal 48 to the ECM 204 to reduce the rate of flow of conventional fuel delivered to the engine 202 during operation of the system 10. Less conventional fuel is required for the engine 202 when the system 10 is operating. The modified oxygen signal 48 will override the “lean” signal normally read by the ECM 204 when less conventional fuel is delivered to the engine 202. This ensures maximum benefits are maintained during operation of the system 10 in terms of engine efficiency and conventional fuel savings.

The integrated logic control unit 30 incorporates various adjusters to set the modified oxygen signal to the appropriate range for the engine 202 in conjunction with the use of an exhaust gas analyser (not shown) as well as set the range of hydrogen flow applicable for that engine (fine tuning). The integrated logic control unit 30 is connected and controls the low pressure regulator shut off valve 25 and also receives a low pressure signal 48 confirming flow in the low pressure line 24.

The integrated logic control unit 30 (ILCU) generates indications via indicator lights 34 on the ILCU and the instrument panel 208 of the vehicle regarding the status of the system 10. These indications include one or more of the following.

| | |
|---|---|
| Master Switch POWER ON | ILCU Only |
| Hydrogen Flow ON | Both ILCU and Instrument Panel |
| Low Hydrogen pressure warning | Both ILCU and Instrument Panel |
| System ON with Fault | Both ILCU and Instrument Panel |
| System SETUP MODE | Both ILCU and Instrument Panel |
| Engine overheat or fire warning | Both ILCU and Instrument Panel |

### System Setup

The system 10 includes an installer and inspection/setup dongle (not shown) which is temporarily connected to the integrated logic control unit 30 to carry out initial programming of the system 10 for a specific installation, including the following: (1) initial set up of the minimum (base flow rate) and the maximum hydrogen flow rate of the proportional valve, (2) connection of a display unit which displays operating parameters, (3) assistance in system inspection at defined intervals from local regulatory body. Minor adjustments and fine tuning of the hydrogen flow rate and the modified oxygen signal can be accomplished by adjusters located in the installer and inspection/setup dongle.

During setup, the following steps are performed in conjunction with a calibrated five gas exhaust analyser:
engine is run at idle, hydrogen flow rate is established at 2 to 3 Litres per minute, manifold pressure and emissions are detected and recorded;
engine is run at half throttle, hydrogen flow rate is established at 3 to 4 Litres per minute, manifold pressure and emissions are detected and recorded; and
engine is run at full throttle, hydrogen flow rate is established at 4 to 5 Litres per minute, manifold pressure and emissions are detected and recorded.

These specific flow rates mentioned above relate to a particular passenger vehicle engine. It is to be understood however that the specific flow rates will vary depending on the application and the type of engine to which the system 10 is to be installed. In some applications, such as in diesel engines, a dynamic test is required where exhaust smoke is analysed. This is an optional task and may only be required upon owner and/or operator request.

From the above, a number of engine operating parameters and characteristics can be deduced. The pressure differential between the engine manifold and the regulator valve output (low pressure line 24) is taken and recorded and the necessary adjustments are made to the hydrogen flow rate in the metered fluid line 28 via the proportional valve 26.

### System Operation

The system 10 is run from a 12 or 24 volt electric supply 210 taken from the ignition accessory supply of the vehicle 200. The electric supply 210 is connected via an ignition switch 211 to a fuse 214 to the master switch 32 in the vehicle cabin which provides ON/OFF control of the system 10 to the vehicle operator/driver. The master switch 32 connects to the integrated logic control unit 30 via line 212.

The system 10 is activated by the vehicle driver/operator. The integrated logic control unit 30 is powered and waits for the engine 202 to be started which provides a signal to the integrated logic control unit 30 that cancels the Engine OFF condition. Operation of the engine 202 and the position of the master switch 32 is then confirmed prior to initiating hydrogen flow by the integrated logic control unit 30.

The integrated logic control unit 30 powers the low pressure shut off valve 25 and the proportional valve 26 to their open positions, allowing hydrogen gas to flow into the pressure regulator valve 20 where it is converted from a high pressure of about 200 BAR to a low pressure of up to 3 BAR, as preset by the system installer.

The proportional valve 26 opens to a position, determined by the integrated logic control unit 30, to provide hydrogen flow to the engine 202 at a desired rate depending on the manifold pressure and/or throttle position switch as programmed. When the throttle is moved by the vehicle operator or by the automatic speed/RPM controller of the engine 202, the manifold pressure and/or throttle position switch varies and the flow rate of hydrogen gas to the engine 202 is varied accordingly via the proportional valve 26.

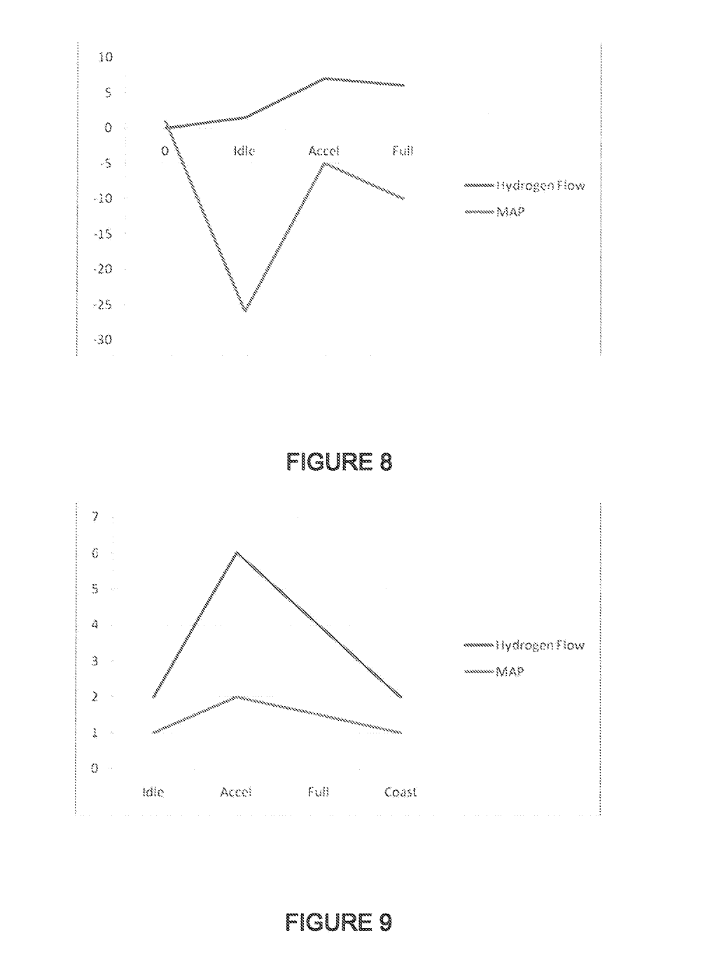

FIG. 8 is a sample diagram showing manifold pressure (MAP) and rate of hydrogen gas flow to a petrol engine across the range of engine OFF, idle, acceleration and full throttle. The integrated logic control unit 30 senses the changes in the input signals and will dynamically position the proportional valve to a programmed position to provide the required hydrogen flow rate. The system 10 provides a flow of hydrogen gas to the engine across the full range of engine operation including at idle speed.

The hydrogen gas is absorbed into the conventional fuel/air mixture, resulting in faster flame propagation and a more efficient combustion process. This reduces negative exhaust emissions, improves power, reduces stress on engine components and reduces conventional fuel consumption.

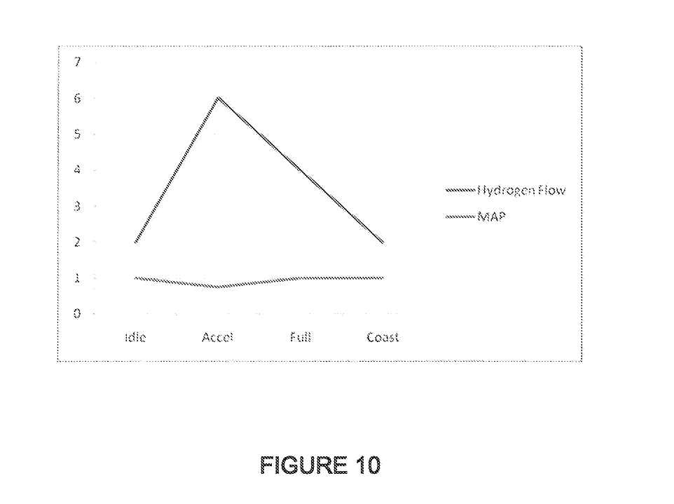

FIG. 9 is a similar diagram to that of FIG. 8 for a turbo diesel engine across the range of idle, acceleration, full throttle and coast. When a turbocharged engine comes under load, the manifold pressure rises and will tend to restrict the hydrogen flow. The proportional valve 26 is programmed to open further to ensure rate of hydrogen flow is appropriate for power operations. FIG. 10 is a similar diagram for a normally aspirated diesel engine across the range of idle, acceleration, full throttle and coast.

At all times, if engine stall is detected, the integrated logic control unit 30 shuts down power to both the low pressure shut off valve 25 and the proportional valve 26 which shuts off the flow of hydrogen gas. The integrated logic control unit 30 can also sense low pressure in the low pressure line 24 and warns the operator that the storage cylinder 12 is close to empty.

The system 10 operates independently to the existing engine fuel system as controlled by the ECM 204. When the system 10 is OFF or shuts down due to a fault, the modified oxygen signal 48 is not generated by the integrated logic control unit 30 and the ECM 204 supplies the normal amount of conventional fuel to the engine 202.

The present system 10 thus provides a number of significant features and benefits. These include: a fully integrated control module, full control of rate of hydrogen gas flow over the entire engine operation range and fine tuning of hydrogen gas flow rate for particular installations. The system 10 provides significant operation advantages and effectiveness compared to other prior systems.

The present system can be installed in any internal combustion engine that uses liquid and gaseous fuels. All these other engines and applications can benefit from the use of an integrated logic control unit for controlling hydrogen gas flow to the engine for fuel enhancement. Other possible applications include: aviation support equipment, trucks, buses, bio fuel powered engines, hybrid engines, generators, rail, mining equipment, gas turbine engines—aviation and ground based, marine engines, and any petrol, LPG, diesel or bio fuel powered engine, rail applications including locomotives, construction equipment, military, aircraft—piston engines and gas turbine engines and auxiliary power units.

### Second Embodiment

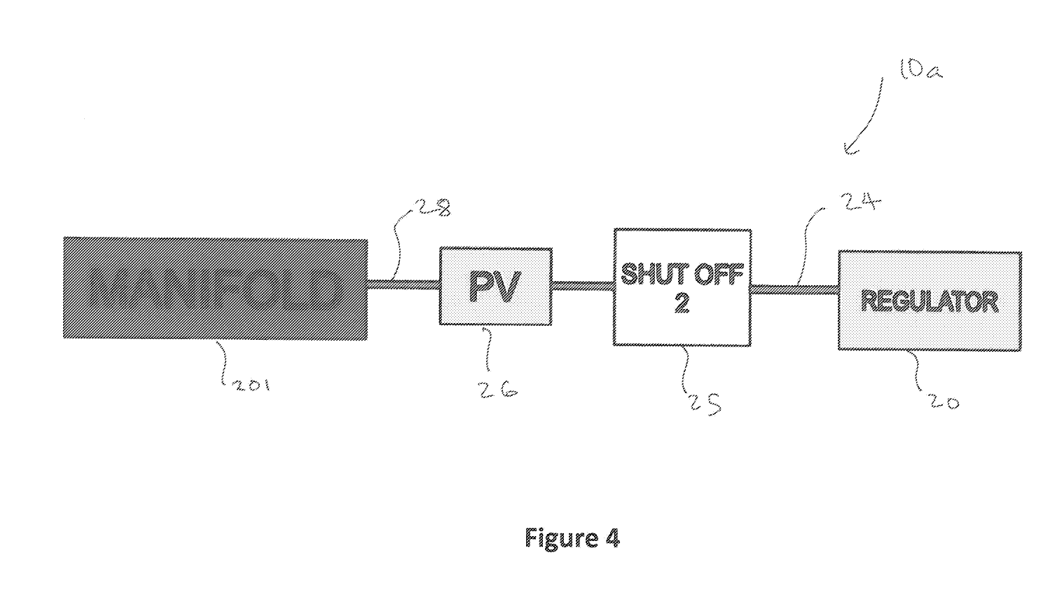

FIG. 4 shows a simplified engine fuel enhancement management system 10a in accordance with a second preferred embodiment of the present invention. In the system 10a, the pressure regulator valve 20 also converts high pressure hydrogen gas from the storage cylinder 12 to a low pressure hydrogen gas which is conveyed to the proportional valve 26 and which is then conveyed to the engine inlet manifold 201. The system 10a however does not use an integrated logic control unit 30 and the proportional valve 26 is set to one specific flow rate only. The system 10a is suitable for use with constant operation speed engines such as generators and turbines.

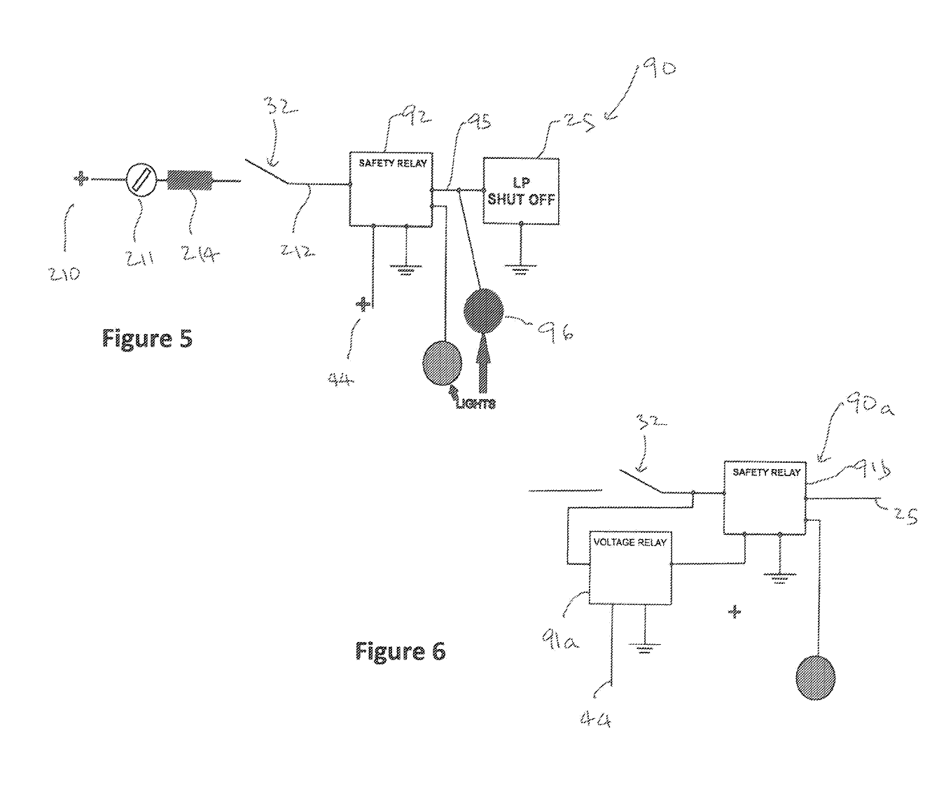

FIG. 5 shows a safety switching system 90 for the engine fuel enhancement management system 10a. The electric line 212 in this embodiment is connected to a safety relay 92. The safety relay 92 also receives the alternator output or oil pressure status 44, which provides the engine ON or OFF status. The safety relay 92 is connected to the low pressure shut off valve 25 via a normally closed line 95 to which a green indicator light 96 is connected. When line 25 is closed, the green light 96 is ON and the low pressure shut off valve 25 is (powered) open to allow hydrogen gas flow. When an engine OFF signal is received, the safety relay 92 cuts off the power to the line 95 which shuts off the low pressure shut off valve 25 and flow of hydrogen gas is stopped.

FIG. 6 shows an alternative safety switching system 90a for the system 10a which uses a voltage relay 91a and a safety relay 91b both connected to the master switch 32. The voltage relay 91a also receives the alternator output or oil pressure status 44, which provides engine ON or OFF status. The safety system 90a energises the low pressure shut off valve 25 and (optionally) the high pressure cylinder shut off valve 18 as follows:
(1) System ON—The system is powered from the driver's master switch 32 to the voltage relay 91a which then waits for an engine operating signal (engine ON) to the safety relay 91b and then energises the low pressure shut off valve 25 and (optionally) the high pressure cylinder shut off valve 18 to allow flow to the engine combustion chamber;
(2) ENGINE OFF—The safety relay 91b loses the engine running signal and immediately causes the low pressure shut off valve 25 and the high pressure cylinder shut off valve 18 to close.

### Third Embodiment

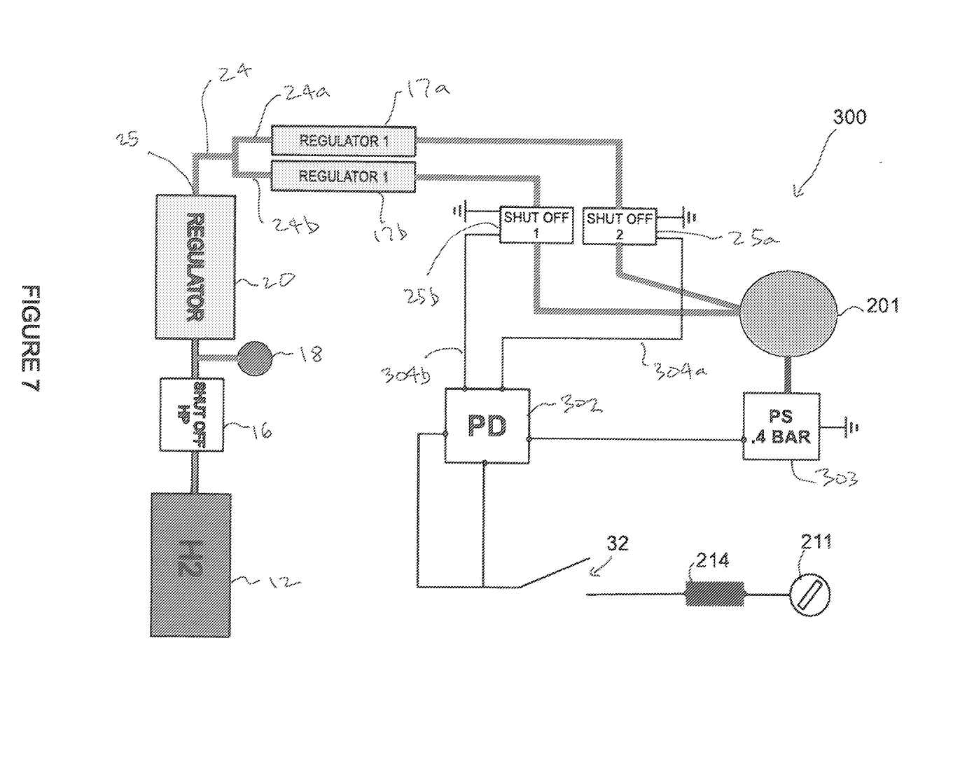

FIG. 7 shows an engine fuel enhancement management system 300 in accordance with a third preferred embodiment of the present invention.

The system 300 also comprises a high pressure storage cylinder 12, a manual high pressure cylinder shut off valve 16, a high pressure gauge 18, and a high pressure to low pressure regulator valve 20. The system 10 also comprises a low pressure shut off valve 25 disposed either at the low pressure supply line 24 or at the regulator valve 20.

In the system 300, the low pressure supply line portion 24 is split into parallel sublines 24a and 24b, each comprising a respective second regulator valve 17a and 17b. The second regulator valve 17a reduces the pressure of the hydrogen gas in the subline 24a to 0.7 Bar and the second regulator valve 17b reduces the pressure of the hydrogen gas in the subline 24b to 1 Bar. Each subline 24a and 24b is connected to the engine inlet manifold 201, and each includes a respective shut off valve 25a and 25b.

The shut off valves 25a and 25b are controlled by a pressure differential solenoid switch 302 via respective connection lines 304a and 304b. The pressure differential solenoid switch 302 is powered via master switch 32 and monitors the manifold pressure via a pressure switch 303. Like the other shutoff valves, the shut off valves 25a and 25b are normally closed and need to be energised open to allow flow. At a manifold pressure differential of less than 0.4 Bar, which coincides with engine IDLE up to ½ throttle, flow is allowed to the manifold 201 via the subline 24a. At a manifold pressure differential of greater than 0.4 Bar, which coincides with engine 1/2 throttle to full throttle, flow is allowed to the manifold 201 via the subline 24b.

Again, it is to be noted that the specific gas pressures mentioned relate to one embodiment only and will vary depending on the type of engine to which the system 300 is installed.

Whilst preferred embodiments of the present invention have been described, it will be apparent to skilled persons that modifications can be made to the embodiments described. For example, additional inputs to the control unit 30 may be added for future modifications. Variations to the circuitry are also possible as technological advances are made as well as addition of high pressure sensors to alert the operator of volume of hydrogen gas left in the cylinder. It is also possible to add an anti-icing system utilising an engine coolant to minimise engine manifold icing. Refilling systems for fixed refillable storage cylinders can also be considered. It is also possible for the storage cylinder to store liquid hydrogen which is converted into compressed hydrogen gas during use.

### Interpretation

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### COMPRISING AND INCLUDING

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### SCOPE OF INVENTION

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the management of any internal combustion engine including reciprocating, rotary piston and gas turbine engine types in the automotive, agricultural, aviation, construction, generators, marine, military, mining and rail industries.

The claims defining the invention are as follows:

1. A system for managing the addition of a fuel additive to an engine which receives a conventional fuel, the system comprising:
a storage means for storing the fuel additive;
a supply line communicating the storage means to the engine; and
a control valve for controlling the rate of addition of the fuel additive from the storage means to the engine.

2. The system of claim 1 wherein the control valve is a proportional valve disposed in the supply line.

3. The system of claim 1 further comprising a control means for dynamically controlling the control valve to vary the rate of flow of fuel additive to the engine in response to current intake manifold pressure and/or throttle position of the engine.

4. The system of claim 1 wherein the storage means is a high pressure storage cylinder.

5. The system of claim 4 wherein the system comprises a high pressure to low pressure regulator valve in the supply line for converting high pressure fuel additive in the storage cylinder to a lower pressure.

6. The system of claim 4 wherein the system comprises a manual high pressure cylinder shut off valve connected to the storage cylinder.

7. The system of claim 5 wherein the supply line comprises a low pressure supply line portion which extends downstream from the regulator valve, the system comprising a low pressure shut off valve in the low pressure supply line portion.

8. The system of claim 5 wherein the system comprises a low pressure shut off valve disposed in the regulator valve.

9. The system of claim 7 comprising a control unit which controls the low pressure shut off valve.

10. The system of claim 7 wherein the control valve comprises a proportional valve in the supply line, the supply line comprising a metered hydrogen line which extends from the proportional valve to the engine.

11. The system of claim 10 comprising a control unit which controls the proportional valve.

12. The system of claim 1 wherein the system comprises a master switch and indicator means.

13. The system of claim 1 wherein the fuel additive is hydrogen gas which is stored in the storage means in compressed form.

14. The system of claim 7 wherein the low pressure cylinder shut off valve is an electronically controlled solenoid shut off valve.

15. The system of claim 2 wherein the proportional valve is an electronically controlled proportional solenoid valve.

16. The system of claim 3 wherein the control means is an integrated logic control unit.

17. The system of claim 16 wherein the integrated logic control unit is a programmable integrated circuit.

18. A system for managing the addition of a fuel additive to an engine which receives a conventional fuel, wherein the supply of conventional fuel to the engine is managed by an engine control module, the system comprising:
a storage means for storing the fuel additive;
a supply line communicating the storage means to the engine; and
a control means for controlling the rate of addition of the fuel additive from the storage means to the engine, wherein the control means is adapted to send a modified signal to the engine control module for the engine control module to supply a reduced amount of conventional fuel to the engine when the system is operating.

19. The system of claim 18 wherein the control means comprises a control unit, the system further comprising a control valve in the supply line and wherein the control unit dynamically controls the control valve to vary the rate of flow of fuel additive to the engine in response to current intake manifold pressure and/or throttle position of the engine.

20. The system of claim 19 wherein the system comprises a high pressure to low pressure regulator valve in the supply line for converting high pressure fuel additive in the storage means to a lower pressure.

21. The system of claim 20 wherein the supply line comprises a low pressure supply line portion which extends downstream from the regulator valve, the system comprising a low pressure shut off valve in the low pressure supply line portion, wherein the control unit controls the low pressure shut off valve.

22. The system of claim 18 wherein the fuel additive is hydrogen gas which is stored in the storage means in compressed form.

23. The system of claim 21 wherein the low pressure shut off valve is an electronically controlled solenoid shut off valve.

24. The system of claim 19 wherein the control valve is an electronically controlled proportional solenoid valve.

25. The system of claim 18 wherein the control means is an integrated logic control unit.

26. The system of claim 18 wherein the system operates independently of the engine control module.

27. A system for managing the addition of a fuel additive to an engine which receives a conventional fuel, the system comprising:
a storage means for storing the fuel additive;
a supply line communicating the storage means to the engine; and
a control means for controlling the rate of addition of the fuel additive from the storage means to the engine, wherein the control means is adapted to add the fuel additive to the engine across an engine operating range between and including engine idle and engine full throttle.

28. A system for managing the addition of a fuel additive to an engine which receives a conventional fuel, the system comprising:
a storage means for storing the fuel additive;
at least two supply lines communicating the storage means to the engine which are adapted to supply the fuel additive to the engine at different rates of flow; and
a switching means for selecting the rate of flow of addition of the fuel additive to the engine between the at least two supply lines.

29. The system of claim 28 wherein each of the at least two supply lines comprise a respective regulator valve.

30. The system of claim 28 wherein each of the at least two supply lines comprise a respective shut off valve.

31. The system of claim 28 wherein the switching means is connected to the shut off valves.

32. The system of claim 28 wherein the switching means comprises a pressure differential solenoid switch which monitors the manifold pressure of the engine.

33. A method of managing the addition of a fuel additive to an engine which receives a conventional fuel, the method comprising:
dynamically controlling the rate of flow of the fuel additive from a storage means to the engine in response to current intake manifold pressure and/or throttle position of the engine.

34. The method of claim 33 further comprising the step of sending a modified signal to an engine control module of the engine, for the control module to supply a reduced amount of conventional fuel to the engine when the fuel additive is being added to the engine.

35. A method of managing the addition of a fuel additive to an engine which receives a conventional fuel, the method comprising:
sending a modified signal to an engine control module of the engine, for the control module to supply a reduced amount of conventional fuel to the engine when the fuel additive is being added to the engine.

36. The method of claim 35 further comprising the step of dynamically controlling the rate of flow of the fuel additive from a storage means to the engine in response to current intake manifold pressure and/or throttle position of the engine.

37. An engine having the system of any one of claims 1 to 32 installed therein.

38. A vehicle having the system of any one of claims 1 to 32 installed therein.
